(19) United States
(12) Patent Application Publication
(10) Pub. No.: US 2025/0328885 A1
(43) Pub. Date: Oct. 23, 2025

(54) METHOD AND SYSTEM FOR SPLIT PAYMENT FOR AN EVENT

(71) Applicant: Crewfare LLC, Weston, FL (US)

(72) Inventor: Jason van Esso, Weston, FL (US)

(73) Assignee: Crewfare LLC, Weston, FL (US)

(21) Appl. No.: 18/643,551

(22) Filed: Apr. 23, 2024

(51) Int. Cl. G06Q 20/22; G06Q 20/08

(52) U.S. Cl. CPC G06Q 20/227; G06Q 20/0855

(57) ABSTRACT

A system or method for splitting payments among multiple parties for an event includes certain operations. The operations can include receiving profile information from an organizer, prompting the organizer for full payment or split payments, and providing the organizer with a payment policy. Upon receiving an indication for split payments, the system prompts inputs for name and contact information of third party participants and further generates split payment calculations for all participants. The system can prompt the organizer to pay their portion based on the split payment calculations and send calculated split payment requests to each of the respective participants using a payment link within an electronic message. The system tracks payments, and upon receiving an indication of receipt of all payments, the system confirms the booking. Upon failing to receive all payments under a split payment policy, the system charges the organizer or participants with a cancellation fee.

### FIELD

The present disclosure is directed to a method and system for splitting payments among friends or a crew, and more particularly to.

### BACKGROUND

Current methods of arranging for group events among friends or affiliation groups typically involves a leader creating a spreadsheet and having to pay via a credit card all the up front fees on behalf of all the friends that plan on attending the event. The event could involve tickets to a concert, a plane trip, one or more taxi rides, hotel rooms and even meals. If all friends were traveling to and from the same location at the same time, then the calculation might turn out to be an even split. Usually, that is not the case where the friends are coming from dispersed locations and different times to reunite at an event. In some instances, the arrangement might exclude travel to and from the event and enabling the participants to arrange their own travel. In either case, the organizer is disproportionately burdened and will also need to reconcile with their friends using a payment plan like Venmo or Zelle.

There are many variables with different travelers that it likely becomes a greater burden in terms of time and money for the organizer, particularly when one of the friends or members of the group drops out or ends up having different plans than originally contemplated.

### SUMMARY

In some embodiments, a system for splitting payments among multiple parties for an event can include a web access front end for entering and retrieving data from a server, one or more processors and memory operatively coupled to the one or more processors having computer instructions which cause the one or more processors to perform certain operations. The operations can include receiving profile information from an organizer, prompting the organizer for full payment or split payments, and providing the organizer with a payment policy including a cancellation fee. In some embodiments, upon receiving an indication for split payments, the system can prompt an input of information of name and contact information of third party participants and further generate split payment calculations for all participants including the third party participants and the organizer upon receiving an indication of a total number of participants. In some embodiments, the system can prompt the organizer to pay their portion based on the split payment calculations and upon payment of the organizer's split payment calculation, send calculated split payment requests to each of the respective third party participants using a payment link within an electronic message. The one or more processors can further include the operations of receiving information from a billing system that tracks payments, upon receiving an indication that all payments due from the organizer and the respective third party participants were received, confirming the booking for the event, and upon failing to receive all payments due from the organizer and the respective third party participants within a period of time based on the payment policy, charging the organizer or the third party participants or a portion of the third party participants with the cancellation fee.

In some embodiments, the profile information of the organizer includes their name, email address, mobile phone number, and/or credit card information.

In some embodiments, the payment policy provides for a predetermined period of time to make one or more payments by the organizer or third party participants.

In some embodiments, the one or more processors are further programmed to offer an installment plan and wherein the system calculates a split of payments based on the number of participants and the installment plan.

In some embodiments, the electronic message is an email with the payment link.

In some embodiments, the event is a combination of one or more of a hotel booking, a flight booking, a bus ride booking, a shared driver booking, a ferry ride booking, a taxi driver booking, a limousine driver booking, a sporting event, a music performance, or a theatrical performance.

In some embodiments, upon failing to receive all payments due from the third party participants, the one or more processors are further programmed to offer an option to allow the organizer or other remaining third party participants to pay on a defaulting individual's behalf.

In some embodiments, upon failing to receive all payments due from the third party participants, the one or more processors are further programmed to offer an option to allow the organizer and at least a portion of remaining third party participants to pay an increased pro-rata share on behalf of a defaulting individual.

In some embodiments, upon failing to receive all payments due from the third party participants, the one or more processors are further programmed to offer an option to allow a customized split among the remaining third party participants and the organizer.

In some embodiments, a system for splitting payments among multiple parties for an event can include a web access front end on a mobile phone application for entering and retrieving data from a server, one or more processors and memory operatively coupled to the one or more processors, wherein the memory includes computer instructions when executed by the one or more processors, causes the one or more processors to perform certain operations. The operations can include receiving profile information from an organizer, prompting the organizer for full payment or split payments, providing the organizer with a payment policy including a cancellation fee, upon receiving an indication for split payments by an organizer, prompting the input of information of name and contact information of one or more friends, upon receiving an indication of a total number of friends, generating split payment calculations for all friends including the one or more friends and the organizer, prompting the organizer to pay their portion based on the split payment calculations, upon payment of the organizer's split payment calculation, sending calculated split payment requests to each of the respective friends using a payment link within an electronic message, receiving information from a billing system that tracks payments from the organizer and the one or more friends, upon receiving an indication that all payments due from the organizer and the respective friends were received, confirming the booking for the event, and upon failing to receive all payments due from the organizer and the respective friends within a period of time based on the payment policy, charging the organizer or the one or more friends or a portion of the one or more friends with the cancellation fee.

In some embodiments, the profile information of the organizer includes at least their name, email address, and mobile phone number.

In some embodiments, the payment policy provides for a predetermined period of time to make one or more payments by all of the one or more friends.

In some embodiments, the one or more processors are further programmed to offer an installment plan and wherein the system calculates a split of payments based on the number of friends and the installment plan.

In some embodiments, the electronic message is an email or a Short Messaging System message with the payment link.

In some embodiments, the event is a combination of one or more of a hotel booking, a flight booking, a bus booking, a shared driver booking, a train booking, a ferry booking, a car rental booking, a sporting event, a music performance, and a theatrical performance.

In some embodiments, upon failing to receive all payments due from the one or more friends, the one or more processors are further programmed to offer an option to allow the organizer or other remaining friends to pay on a defaulting individual's behalf.

In some embodiments, a method for splitting payments among multiple parties for an event can include entering and retrieving data from a server using a web access front end using one or more processors, receiving profile information input from an organizer, prompting the organizer for full payment or split payments, providing the organizer with a payment policy including a cancellation fee, upon receiving an indication for split payments by an organizer, prompting an input of information of name and contact information of one or more friends participating in the event, upon receiving an indication of a total number of friends, generating split payment calculations for all friends including the one or more friends and the organizer, prompting the organizer to pay their portion based on the split payment calculations, upon payment of the organizer's split payment calculation, and sending calculated split payment requests to each of the respective friends using a communication system using a payment link within an electronic message. The method can further include receiving information from a billing system that tracks payments from the organizer and the one or more friends, upon receiving an indication that all payments due from the organizer and the respective friends were received, confirming the booking for the event, and upon failing to receive all payments due from the organizer and the respective friends within a period of time based on the payment policy, charging the organizer or the one or more friends or a portion of the one or more friends with the cancellation fee.

In some embodiments, upon failing to receive all payments due from the one or more friends, the method offers an option to allow the organizer or other remaining friends to pay on behalf of a defaulting individual.

### BRIEF DESCRIPTION OF DRAWINGS

The accompanying drawings, which are incorporated in and constitute a part of this description, illustrate embodiments consistent with the embodiments and, together with the description, serve to explain the principles of the embodiments

FIG. 1 illustrates a flow chart of a method for splitting payments among multiple parties for an event in accordance with the embodiments.

FIG. 2 is a user interface prompting an organizer to split payments with friends or third party participants in accordance with the embodiments.

FIG. 3 is another user interface providing information about a payment policy in accordance with the embodiments;

FIG. 4 is another user interface prompting the organizer or booker to list all the friends or third party participants in accordance with the embodiments;

FIG. 5 is another user interface enabling the organizer or booker to set the split payments as equally among the participants or in a customized fashion in accordance with the embodiments;

FIG. 6 is another user interface providing status information and enabling the organizer or booker to send a split payment request to one or more friends or third party participants in accordance with the embodiments;

FIG. 7 illustrates a block diagram of a system for splitting payments among multiple parties in accordance with the embodiments.

### DETAILED DESCRIPTION OF DRAWINGS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the embodiments. Instead, they are merely examples of systems, apparatuses and methods consistent with aspects related to the embodiments as recited in the appended claims.

The system, now known as “Crewpay” is a first-of-its-kind payment system and method allowing users to split payments at checkout with friends or third party participants. Rather than having the organizer pay a large hotel expense (or other expense) up-front and have to reconcile on yet another payment system such as Venmo or Zelle, users can customize how they split their rooms and extras with their group. Each group member receives a dedicated payment link to pay. This technology allows groups to easily and conveniently go to places and participate in events within minimal burden to an organizer and the respective participants or friends. It further allows the parties to aggregate all aspects for the event including not only the hotel or boarding aspects, but also the registration for an event and associated travel for each of the participants. Other aspects can further be aggregated such as related merchandise for an event such as apparel or fan paraphernalia.

The system will have a split payment plan policy which will control how friends are invited, how payments are split and even how cancellations will be treated. Each event may have a different policy and the user is encouraged to review such policies. In some embodiments, it may be a requirement for the user to acknowledge the viewing of such policy before proceeding further.

The system and method are an easy and convenient option for customers who want to split payment among friends at checkout. Customers who use the system can be allowed to reserve the booking for the whole group, while only having to pay for their part of the payment upfront. The rest of the group will have a certain period of time such as a certain number of hours, listed in the policies of the checkout page, to pay for their portion of the payment.

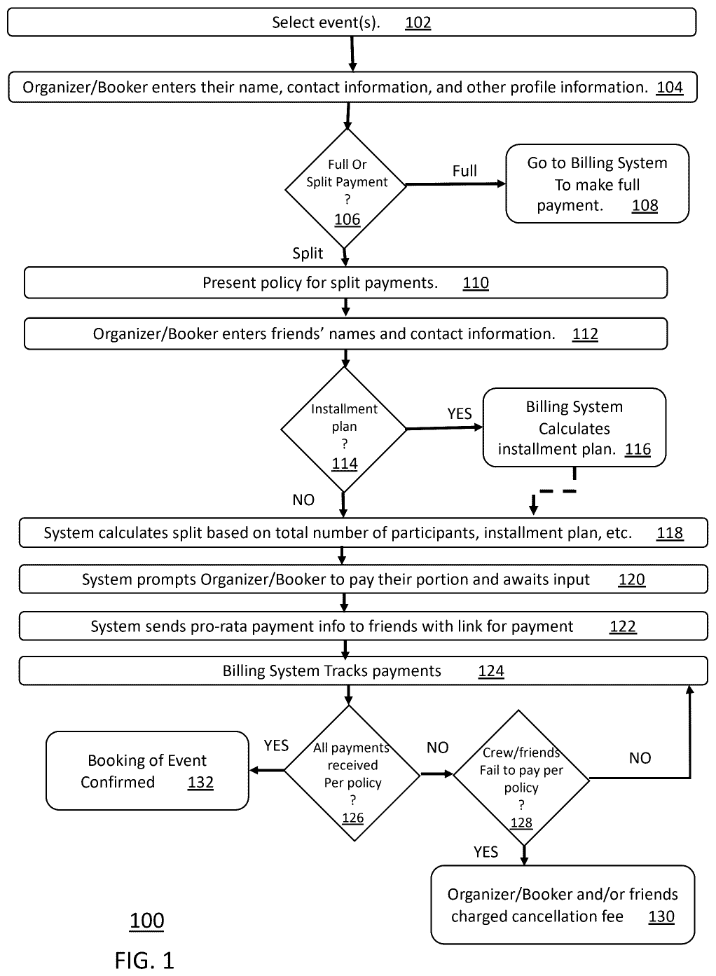

Referring to the flow chart of FIG. 1, a method 100 discloses the various steps taken in an exemplary embodiment. The user can select the event at 102. The original organizer or booker or user can also enter their name, contact information, and other profile information at step 104. In some embodiments, the profile information can include payment methods such as credit cards, debit cards, and bank accounts that may already be included as part of the user's profile. An event can be given a broad interpretation and can be any combination of things and include not only tickets to a musical, theatrical or sporting event, but other items such as hotel bookings, flight bookings, train bookings, shared ride bookings, ferries, ship bookings, or participation or entry fees to an athletic competition for example. In some embodiments, the original organizer can also recommend the purchase of merchandise associated with an event for the third party participants or friends to purchase as an option. The system can account for such “extras” and charge the respective purchasers accordingly if they choose to purchase such extras.

At checkout, the organizer or original booker can be presented with the option of selecting to purchase their bookings through the system at 106. The original booker can select full payment and proceed to make the full payment at 108. At 106, the system will also allow the original booker to select a split payment option where the original booker or organizer is presented with the policy for split payments at 110. At 112, the organizer or original booker can enter the number of individuals splitting the cost or simply enter each of the corresponding names and contact information such as email addresses or mobile phone numbers (for SMS messaging) for the other individuals and the system will automatically know how many individuals after the organizer confirms the entry of all participants or friends. The system at 114 can optionally provide the user with an installment plan where a billing system at 116 can calculate the split payments under the installment plan for each of the participants (including the organizer) per a given payment plan. If no installment plan is desired, the system can continue and calculate the split payments at 118. The system can prompt the original booker or organizer with a prompt to make their pro-rata share payment at 120 and enable the messaging of payments (via email, SMS or other electronic messaging system) at 122. The electronic messages to each of the participants or friends can include a payment link for easy payment. At step 124, the billing system can track all the payments from the organizer and the invited friends or participants. At decision block 126, if all payments are received from all participants, then the booking is confirmed at 132. If all the payments are not made at decision block 126, then another decision block 128 determines if the friends or participants have failed to pay per the payment policy. If they have not failed yet, then the method continues to track payments at 124. At the decision block 128, if a determination that the friends or participants have collectively failed per the payment policy, then the organizer/booker and/or friends are charged a cancellation fee per the payment policy at 130.

In some embodiments, assuming all proceeds as contemplated, the original booker's credit card will be charged at checkout and the other individuals will receive an email with a link to a payment form. The other individuals can then make their respective payments and they can optionally purchase other extras after assuring payment of their pro-rata or appropriate share.

In some embodiments, the rest of the group then has a certain number of hours, as listed in the policies on the checkout page, to pay for their individual portion of the payment. Once the entire group has provided payment, the order will be confirmed. If the group does not pay in full within that period of time listed in the policies on the checkout page, then the transaction will be cancelled, and the original booker will be charged a cancellation fee as listed on the policies of the checkout page. The cancellation will apply to the specific booking where payment was not submitted, and all other bookings associated with the group will be confirmed with payment.

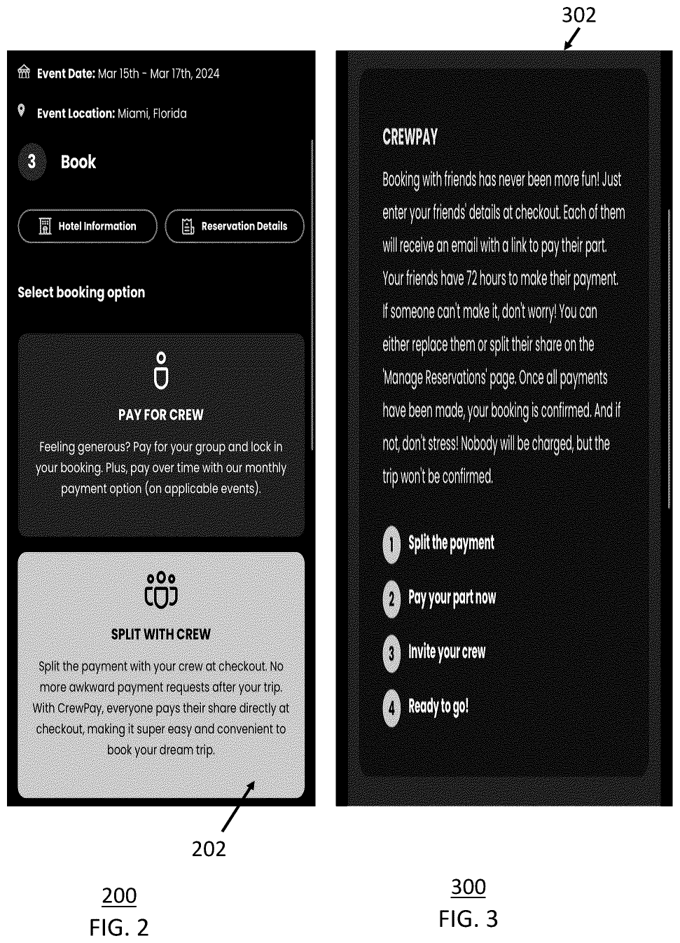

FIG. 2 illustrates a user interface 200 where an event can be booked (such as a hotel booking) where the original booker can either pay for all the participants or split the payments with the option at 202. If the split payment option at 202, another user interface 300 with a portion at 302 illustrated in FIG. 3 presents the details of “CrewPay” or the payment policy which can include a cancellation policy.

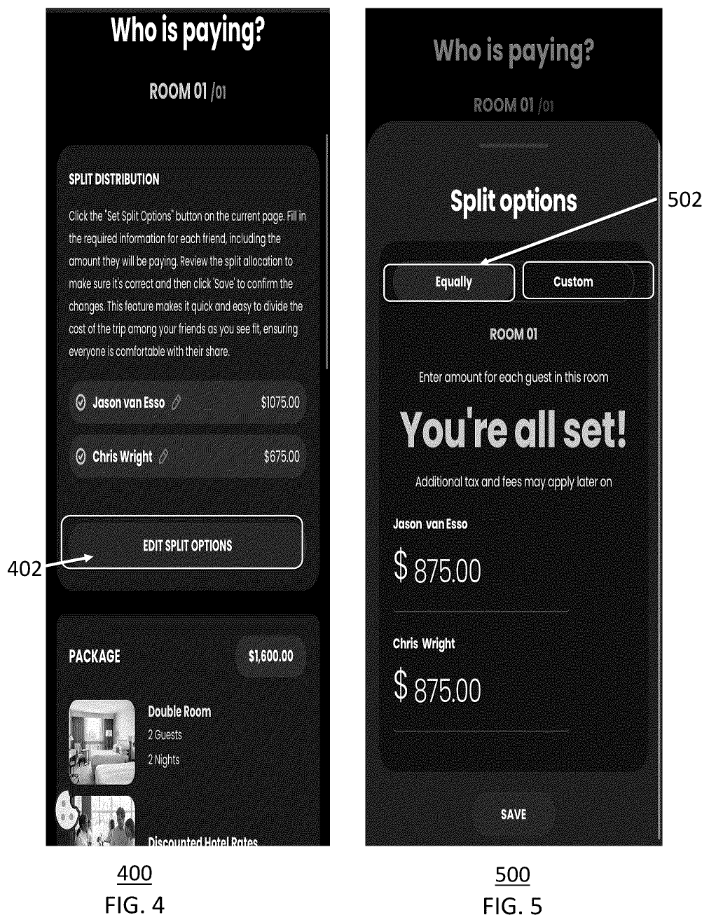

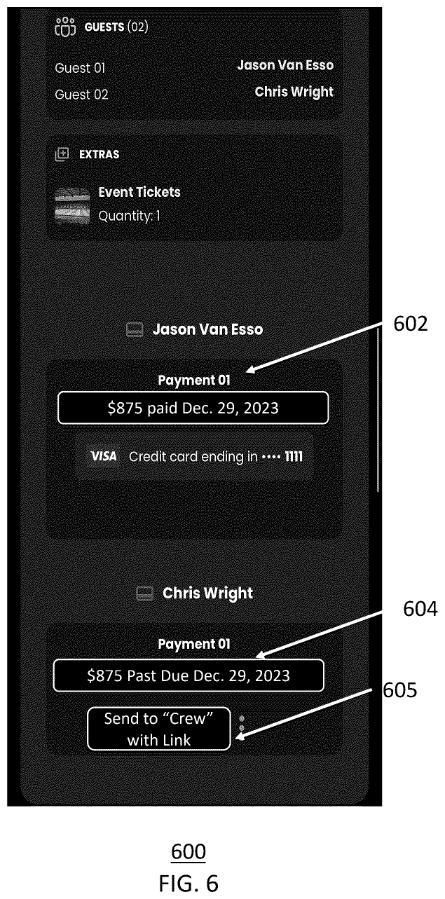

Another user interface shown in FIG. 4, enables a user such as the original booker or organizer to select which individuals will the payment be split among and allows the user to add their contact information. The user can then proceed and select the “Edit Split Options” option or button 402 whereupon the user interface 500 of FIG. 5 presents the split options of a custom split or an equal split at 502. If an equal split is selected, then a user interface 600 of FIG. 6 presents the payment status (602 and 604) and options to send a link to the “crew” or friends that includes a payment link at 605.

In some embodiments, the system can provide for an installment plan (as shown at 114, FIG. 1). In some embodiments, at Checkout, the original booker can be presented with the option of selecting to purchase their bookings through the CrewPay system and opting to submit payments via installations. The original booker will then select how many individuals will be splitting the cost, which will determine the total sum owed by each individual at each installation payment date. The original booker will then enter the email addresses for the other individuals and provide their own payment information. The original booker's credit card will be charged the first installation payment sum provided at checkout, and the other individuals will receive an email or other electronic message with a link to a payment form.

In some embodiments, the rest of the group then has a certain period of time such as a number of hours, as listed in the policies on the checkout page, to pay for their individual portion of the first installation payment. Once the entire group has provided payment, the order will be confirmed.

If one (1) or multiple individuals in the group do not pay subsequent installation payment balances due at the time period listed in the policies on the checkout page, that individual will be presumed to be in default of payment. In some embodiments, the defaulting individual can have a number of opportunities such as three (3) opportunities to submit payment. If by the third (3rd) reminder to submit payment the defaulting individual has not proceeded to pay the balance owed, the other individuals associated with the confirmed booking will have the opportunity to: 1) submit payment on the defaulting individual's behalf or 2) remove the defaulting individual from the confirmed booking by replacing the contact information with a new individual where the new individual will have a certain number of hours to submit payment and can opt to pay the amount of the confirmed booking in full or on the same installment schedule as the group.

If payment is submitted on the defaulting individual's behalf, the system can provide various options for the remaining individual to pay. In one instance, one other remaining individual can pay on the defaulting individual's behalf. In another instance, all the other remaining individuals can pay an increased pro-rata share automatically calculated by the system once the defaulting individual is deleted from the booking. In yet another instance, the system can allow selection of remaining individuals that can pay an increased pro-rata share among the selected individuals that would then replace the defaulting individual's share. The system will also allow a custom split among the remaining individuals if desired. In yet another instance, one or more additional participants can be added and pro-rata shares of payments would then be re-calculated.

If the individuals on the confirmed booking do not 1) submit payment on the defaulting individual's behalf or 2) replace the defaulting individual on the confirmed booking within that period of time listed in the policies on the checkout page, then the transaction will be canceled, and the original booker and/or the friends will be charged a cancellation fee as listed on the policies of the checkout page.

In general, payments made through the system are non-refundable since a commitment is being made.

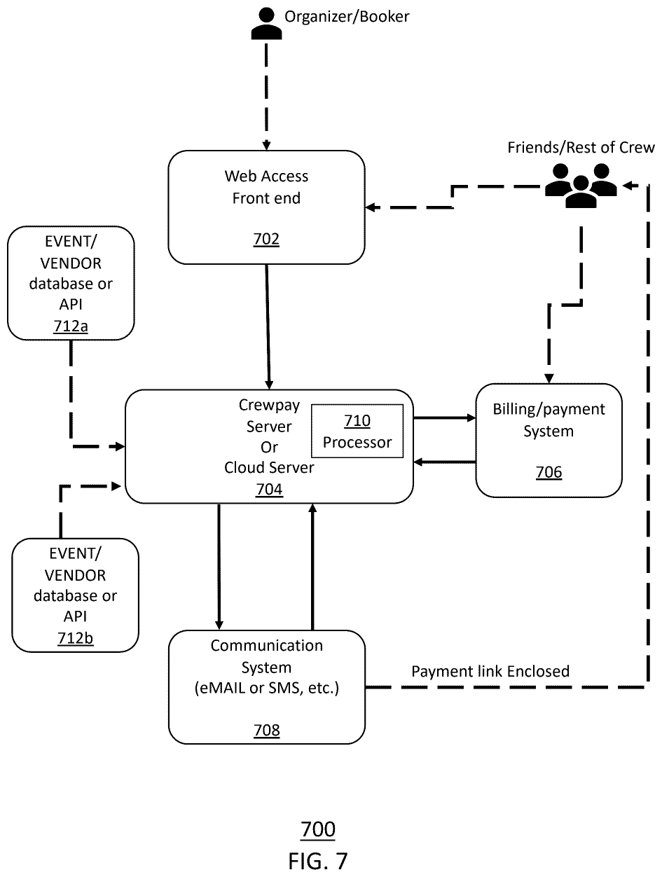

In reference to a system 700 for splitting payments as shown in FIG. 7, such a system can include a web access front end 702 enabling a user such as an organizer or booker to interface with a server 704 that enables such split payments. The server 704 can include one or more processors 710. The server can interface with a number of other systems in order to integrate the process for the organizer or booker. For example, the server 704 can interface with one or more event or vendor databases or APIs 712a, 712b. The system aggregates the services or goods being offered from each of the vendor databases or APIs into a single system allowing for the user's ease of use in splitting payments. For example, the event database or API can be a hotel chain or car rental agency or shared ride system. The event database or API can also be a conglomerator of travel services like Expedia or Travelocity. In other embodiments, the event database or API can be a music venue, theater venue, sports venue, or a ticket vendor for such events. In some embodiments, the event database or API can be a registration database for participating in a sporting event such as a 5K or marathon, a triathlon, a fishing tournament, a golfing tournament, or any other type of participatory event. Further note that the system 700 allows a user to aggregate “events” from different sources. For example, one split payment scenario can include a crew splitting a combination of a hotel stay, music festival tickets, and airplane tickets. In some embodiments, the system can accommodate or make adjustments where only hotel stays and tickets of the same class are equally split among the participants and where each of the participants further pay their respective portions for travel. In other words, if the travel arrangements have participants coming from different locations with different costs involve, then each of the participants will pay their respective travel costs and otherwise equally split costs for hotel stays and tickets.

In some embodiments, the server 704 can interface with a billing or payment system 706 as well as a communication system 708 which can be an email server or an SMS server or other communication messaging server. As discussed above, once the split payment details are set, the user can send a payment link via the communication system 708 to the friends or remaining participants who can then make payments via the communication system 708 or otherwise. Such payments by the remaining friends will be tracked by the billing or payment system 706 either directly or indirectly based on how the system is set up and how the friends choose to make their payments.

In some embodiments, the system 700 can use a proprietary algorithm for making payments that are dynamically allocated based on changes made in real time to events and other factors. The system is referred to herein as the Dynamic Event Payment Allocation System (DEPAS). In some embodiments, the objective of DEPAS is to dynamically calculate and adjust individual payment shares for an event based on real-time factors such as changes in participation, costs, and individual preferences.

In a first step, an Initial Profile and Event Cost is Input. The Input is where the Organizer inputs initial event details including total cost, number of participants, and any specific preferences or contributions (e.g., some participants may opt for higher-cost options). As part of the process, DEPAS stores this information and calculates an initial even split or based on predefined preferences.

In a second step, DEPAS performs a Dynamic Adjustment Based on Real-time Variables. The Real-time variables can include participant count changes, cost adjustments (e.g., ticket prices rise, group discounts applied), and/or updated participant preferences. The process of the second step can include the following: (1) Participant Adjustment: Automatically adjust payment shares when participants are added or removed; (2) Cost Adjustment: Recalculate shares based on cost changes, maintaining the fairness of the initial setup; and (3) Preference Adjustment: Reallocate shares when participants change their preferences (e.g., opting in or out of certain activities).

In a third overall step for DEPAS, the system includes a payment link generation and distribution. The process includes the generation and distribution of personalized payment links reflecting the updated shares. The system also provides options for participants to review and contest the calculations before finalizing payments.

A fourth overall step for DEPAS can include payment tracking and a final adjustment. Tracking allows the system to monitor received payments and automatically send reminders for pending shares. The Final Adjustment occurs before the payment deadline where the system performs one last adjustment pass, considering any last-minute changes or payments before finalizing the shares.

Some of the key features of DEPAS in some embodiments includes real time adaptability and modular design. With respect to adaptability, the system is capable of adjusting to changes instantaneously, ensuring the most current event details are always reflected in the payment calculations. With respect to modular design, the system is easily integrated with different event types and payment systems, offering a scalable solution for various event sizes and complexities.

In some embodiments with respect to implementation considerations, DEPAS would be implemented using a combination of front-end interfaces for input and adjustments, back-end databases for storing event and participant details, and secure APIs for payment processing. Advanced programming concepts such as object-oriented design and in some instances machine learning for predicting participant behavior and preferences could be applied to enhance its functionality.

In some embodiments with reference to any of the embodiments and the claims, the various components or steps can be arranged and configured to be in any order or in any number of parameters, positions and sizes as required for a particular embodiment. Some embodiments with smaller dimensions or parameters would likely be better suited for portable embodiments.

In interpreting the present disclosure and the claims, references of the form “A and/or B” encompass any and every combination and subcombination of the elements A and B, namely any or all of the following: (i.) A, (ii.) B, (iii.) A or B, and (iv.) A and B. References of the form “A, B, and/or C” likewise encompass any and every combination and subcombination of elements A, B, and C). Where the present disclosure or any of the claims may recite “a” or “a first” item or the equivalent thereof, such disclosure includes one or more such items and does not require or exclude two or more such items. Numerical or ordinal terms such as “first”, “second”, “third” etc. when used to refer to items are used solely to identify the items, and do not require or limit the number of such items elements and do not indicate, require or limit a particular position or order of such items unless expressly and clearly stated otherwise.

Descriptions made with reference to “embodiment”, “embodiments”, “some embodiments”, “an embodiment”, “preferred embodiment”, “other embodiments”, “alternative embodiments”, “various embodiments” or the like mean that the description is applicable to at least one embodiment but not necessarily all embodiments. The terms “comprising”, “including”, “having”, and the like, as used with respect to one or more embodiments, are synonymous. In some cases, features, items, steps or other subject matter are described herein as being optional or using terms such as “optional” or “optionally”. However, lack use of such terms in connection with the description of any other features, items steps or other subject matter does not in any way mean or imply that such other features, items steps or other subject matter are required or are not optional.

As an aid to understanding, various actions, operations or steps may sometimes be presented herein or described herein in sequence. However, the order of the description or written presentation herein is not to be construed to mean or imply that such must necessarily occur in a corresponding order or sequence unless otherwise expressly and clearly stated or logically essential. Some actions, operations or steps may permissibly be performed in an order or sequence other than the order of their description or written presentation herein unless otherwise expressly and clearly stated or logically essential. Unless otherwise expressly and clearly stated or logically essential. Unless otherwise expressly and clearly state or logically essential, actions, operations or steps described herein may be combined or divided. Unless otherwise expressly and clearly stated or logically essential, any description herein of any one or more actions, operations or steps does not preclude any one or more other preceding, succeeding and/or intervening actions, operations or steps irrespective of whether or not such preceding, succeeding and/or intervening actions, operations or steps are described or disclosed herein.

Unless otherwise expressly and clearly stated or logically essential, any illustration, description, or reference herein of any one or more items, structures or elements being “connected to”, “coupled to”, “joined to”, “joined with”, “attached to”, “mounted to”, “mounted in”, or “secured to” any one or more other specified items, structures or elements shall not be construed to preclude such connection, coupling, joint, attachment, mounting or securement being either made indirectly, by way of one or more other specified or unspecified items structures or elements, or being made directly.

Unless otherwise expressly and clearly stated or logically essential, any illustration, description, or reference herein of any one or more items, structures, or elements “adjoining”, any one or more other specified items, structures or elements, shall be construed to permit that such may adjoin either direct or indirectly. The term “adjoining” permits, but does not require, preclude the presence of items, structures or elements interposed between those describes as adjoining. Unless otherwise expressly and clearly stated or logically essential, any illustration, description, or reference herein to any one or more items, structures or elements being “beneath”, “below”, “above”, “behind”, “in front of”, “between”, “under”, “over”, “in”, “within”, “outside”, “inside”, any one or more other specified items, structures or elements and/or any other prepositions or prepositional phrases shall construed in a manner which permits, but does not require, contact or immediacy and any and all other prepositions and/or prepositional phrases shall be construed in that same manner.

As used herein, the term “material” encompasses, without limitation, unblended materials having a single constituent, blended materials having two or more constituents, composite materials, homogeneous materials and non-homogeneous materials.

While the embodiments have been described with reference to various preferred embodiments, it will be understood by those skilled in the art that various changes may be made and equivalents substituted for elements thereof without departing from the scope of the embodiments and that modifications may be made to adapt to a particular situation or application of the embodiments without departing from the scope. The embodiments within the scope of the claims are not limited to the particular embodiments disclosed. Rather, the claims cover all embodiments which are within the scope of the claims, either literally or under the Doctrine of Equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description

1. A system for splitting payments among multiple parties for an event, comprising:
a web access front end for entering and retrieving data from a server;
one or more processors and memory operatively coupled to the one or more processors, wherein the memory includes computer instructions which when executed by the one or more processors, causes the one or more processors to perform the operations of:
receiving profile information from an organizer;
prompting the organizer for full payment or split payments;
providing the organizer with a payment policy including a cancellation fee;
upon receiving an indication for split payments, prompting the input of information of name and contact information of third party participants;
upon receiving an indication of a total number of participants, generating split payment calculations for all participants including the third party participants and the organizer;
prompt the organizer to pay their portion based on the split payment calculations;
upon payment of the organizer's split payment calculation, send calculated split payment requests to each of the respective third party participants using a payment link within an electronic message;
receiving information from a billing system that tracks payments;
upon receiving an indication that all payments due from the organizer and the respective third party participants were received, confirm the booking for the event;
upon failing to receive all payments due from the organizer and the respective third party participants within a period of time based on the payment policy, charging the organizer or the third party participants or a portion of the third party participants with the cancellation fee.

2. The system of claim 1, wherein the profile information of the organizer comprises their name, email address, mobile phone number, and credit card information.

3. The system of claim 1, wherein the payment policy provides for a predetermined period of time to make one or more payments by the organizer or third party participants.

4. The system of claim 1, wherein the one or more processors are further programmed to offer an installment plan and wherein the system calculates a split of payments based on the number of participants and the installment plan.

5. The system of claim 1, wherein the electronic message is an email with the payment link.

6. The system of claim 1, wherein the event is a hotel booking.

7. The system of claim 1, wherein the event is a music performance and a hotel booking.

8. The system of claim 1, wherein the event is a combination of one or more of a hotel booking, a flight booking, a bus booking, a shared driver booking, a train booking, a music performance, a sports performance, a registration for participation, and a theatrical performance.

9. The system of claim 1, wherein upon failing to receive all payments due from the third party participants, the one or more processors are further programmed to offer an option to allow the organizer or other remaining third party participants to pay on a defaulting individual's behalf.

10. The system of claim 1, wherein upon failing to receive all payments due from the third party participants, the one or more processors are further programmed to offer an option to allow the organizer and at least a portion of remaining third party participants to pay an increased pro-rata share on behalf of a defaulting individual.

11. The system of claim 1, wherein upon failing to receive all payments due from the third party participants, the one or more processors are further programmed to offer an option to allow a customized split among the remaining third party participants and the organizer.

12. A system for splitting payments among multiple parties for an event, comprising:
a web access front end on an mobile phone application for entering and retrieving data from a server;
one or more processors and memory operatively coupled to the one or more processors, wherein the memory includes computer instructions when executed by the one or more processors, causes the one or more processors to perform the operations of:
receiving profile information from an organizer;
prompting the organizer for full payment or split payments;
providing the organizer with a payment policy including a cancellation fee;
upon receiving an indication for split payments by an organizer, prompting the input of information of name and contact information of one or more friends;
upon receiving an indication of a total number of friends, generating split payment calculations for all friends including the one or more friends and the organizer;
prompt the organizer to pay their portion based on the split payment calculations;
upon payment of the organizer's split payment calculation, send calculated split payment requests to each of the respective friends using a payment link within an electronic message;
receiving information from a billing system that tracks payments from the organizer and the one or more friends;
upon receiving an indication that all payments due from the organizer and the respective friends were received, confirm the booking for the event;
upon failing to receive all payments due from the organizer and the respective friends within a period of time based on the payment policy, charging the organizer or the one or more friends or a portion of the one or more friends with the cancellation fee.

13. The system of claim 12, wherein the profile information of the organizer comprises at least their name, email address, and mobile phone number.

14. The system of claim 12, wherein the system further includes a Dynamic Event Payment Allocation System (DEPAS) that dynamically provides a participant adjustment for automatically adjusting payment shares when participants are added or removed, a cost adjustment that recalculate shares based on cost changes, and a preference adjustment that reallocates shares when participants change their preferences when they opt in or out of events.

15. The system of claim 12, wherein the one or more processors are further programmed to offer an installment plan and wherein the system calculates a split of payments based on the number of friends and the installment plan.

16. The system of claim 12, wherein the electronic message is an email or a Short Messaging System message with the payment link.

17. The system of claim 12, wherein the event is a combination of one or more of a hotel booking, a flight booking, a bus booking, a shared driver booking, a car rental booking, a music performance, and a theatrical performance.

18. The system of claim 12, wherein upon failing to receive all payments due from the one or more friends, the one or more processors are further programmed to offer an option to allow the organizer or other remaining friends to pay on a defaulting individual's behalf.

19. A method for splitting payments among multiple parties for an event, comprising:
entering and retrieving data from a server using a web access front end using one or more processors;
receiving profile information input from an organizer;
prompting the organizer for full payment or split payments;
providing the organizer with a payment policy including a cancellation fee;
upon receiving an indication for split payments by an organizer, prompting an input of information of name and contact information of one or more friends participating in the event;
upon receiving an indication of a total number of friends, generating split payment calculations for all friends including the one or more friends and the organizer;
prompting the organizer to pay their portion based on the split payment calculations;
upon payment of the organizer's split payment calculation, sending calculated split payment requests to each of the respective friends using a payment link within an electronic message;
receiving information from a billing system that tracks payments from the organizer and the one or more friends;
upon receiving an indication that all payments due from the organizer and the respective friends were received, confirming the booking for the event;
upon failing to receive all payments due from the organizer and the respective friends within a period of time based on the payment policy, charging the organizer or the one or more friends or a portion of the one or more friends with the cancellation fee.

20. The method of claim 19, wherein upon failing to receive all payments due from the one or more friends, the method offers an option to allow the organizer or other remaining friends to pay on behalf of a defaulting individual.
